(19) United States
(12) Patent Application Publication
(10) Pub. No.: US 2015/0067458 A1
(43) Pub. Date: Mar. 5, 2015

(54) SYSTEM, METHOD, AND APPARATUS FOR DOCUMENTING THE CONDITION OF TANGIBLE PROPERTY

(71) Applicant: Record360 Inc., Newark, DE (US)

(72) Inventors: Shane Danny Skinner, Seattle, WA (US); Gregory Harrison, Seattle, WA (US); Damon Andrew Haber, Manhattan Beach, CA (US)

(21) Appl. No.: 14/534,846

(22) Filed: Nov. 6, 2014

Related U.S. Application Data
(63) Continuation-in-part of application No. 13/959,581, filed on Aug. 5, 2013.

(51) Int. Cl. G06F 17/24

(52) U.S. Cl. CPC G06F 17/241
USPC 715/201

(57) ABSTRACT

The embodiments disclosed herein include systems, methods, and apparatuses for documenting the condition of tangible property. In preferred embodiments, a method for documenting conditions of tangible property with a client device include capturing, by the client device, image data, wherein the image data includes image data of the property, generating annotation data based on a determined feature of the image, and associating the annotation data with a region of the image data, wherein the region of the image data includes the determined feature of the property. The method may also include capturing, by the client device, additional image data, wherein at least a portion of the annotation data is displayed by the client device when capturing the additional image data and generating documenting data based on the image data, the annotation data, and the additional image data, wherein the documenting data documents a first condition of the property.

### PRIORITY CLAIM

This patent application is a Continuation-in-Part of U.S. application Ser. No. 13/959,581 entitled SYSTEM, METHOD, AND APPARATUS FOR ASSESSING THE CONDITION OF TANGIBLE PROPERTY THAT IS LOANED, RENTED, LEASED, BORROWED, OR PLACED IN THE TRUST OF ANOTHER PERSON, filed on Aug. 5, 2013, the contents of which are hereby incorporated by reference.

### FIELD OF THE INVENTION

The present invention relates generally to documenting a condition of property, and more particularly, but not exclusively, to documenting a condition of real and/or personal property at a time when possession of the property is transferred to a party and to archiving the documented condition for subsequent access.

### BACKGROUND OF THE INVENTION

It is not always economically efficient to acquire an ownership interest in property that one plans to utilize for only a limited time. Thus, property is often loaned, rented, leased, borrowed, or otherwise placed in the temporary possession of a party not wishing to purchase an ownership in the property. Renters, or other parties that take temporary possession of property, may be subject to damage liability if the property is returned in a condition that substantively varies from the condition of the property when the renter first took possession. In order to assure accountability for damages that occur during a rental period and reduce disputes, parties to such a transaction may wish to document the condition of the property at the time when possession is initially transferred to the renter. Thus, it is with respect to these considerations and others that the present invention has been made.

### SUMMARY OF THE INVENTION

The embodiments disclosed herein include systems, methods, and apparatuses for documenting the condition of tangible property. In a preferred embodiment, a method for documenting conditions of tangible property with a client device include capturing, by the client device, image data, wherein the image data includes image data of the property, generating, by the client device, annotation data based on a determined feature of the image, and associating the annotation data with a region of the image data, wherein the region of the image data includes the determined feature of the property. The method may also include capturing, by the client device, additional image data, wherein at least a portion of the annotation data is displayed by the client device when capturing the additional image data and generating documenting data based on the image data, the annotation data, and the additional image data, wherein the documenting data documents a first condition of the property.

In some embodiments, wherein capturing the image data includes capturing video data and generating the annotation data occurs concurrently with capturing at least a portion of the video data. In at least one embodiment, capturing the image data includes capturing video data and generating the annotation data occurs concurrently with capturing at least a portion of the video data. Generating annotation data may occur concurrently with capturing at least a portion of the image data.

In at least one embodiment, the generated annotation data includes at least one notation overlay selected from a plurality of notation overlays. The method may include at least one of enabling a user of the client device to control a review of at least a portion of the image data by utilizing a progress ribbon or blending at least a portion of the annotation data with at least a portion of the image for simultaneous display on a display of the client device. In various embodiments, the region of the image data that is associated with the annotation data corresponds to a portion of a display of the client device that is selected by a user of the client device.

Computer readable non-transitive storage media are disclosed herein. At least some of the media includes instructions for documenting conditions of tangible property. The instructions include actions to execute methods. Also discloses are various systems for documenting conditions of tangible property.

### BRIEF DESCRIPTION OF THE DRAWINGS

Preferred and alternative examples of the present invention are described in detail below with reference to the following drawings:

FIG. 1 illustrates a system environment in which various embodiments may be implemented.

FIG. 2 shows a server device that may be included in various embodiments.

FIG. 3 illustrates a client device that may be included in various embodiments.

FIG. 4 illustrates a logical flow diagram generally showing one embodiment of an overview process for assessing the condition of property that is transferred to a first party and subsequently transferred to a second party.

FIG. 5 illustrates a logical flow diagram generally showing one embodiment of a process for documenting a condition of property based on image data.

FIG. 6 illustrates a logical flow diagram generally showing another embodiment of a process for documenting a condition of property based on image data.

### DETAILED DESCRIPTION OF THE PREFERRED EMBODIMENT

Currently, rental companies, such as car rental, property managements, and the like, sometimes use standardized paper forms to document the existence of preexisting damage of the real and/or personal property, or lack thereof, before a renter takes possession of the property. For instance, a paper form may be used to document the exterior of a car before a renter takes possession of the car. The standardized form may be included in the rental contract or other paperwork associated with the rental transaction. The standardized form may include one or more figures of the car. When the renter takes possession of the car, the car may be inspected. During the inspection, the condition of the car may be documented. Either the renter, or an agent of the car rental company may manually mark-up or otherwise annotate the figures on the standardized form to indicate existing damage to the car. At least one of the renter or the agent of the rental company may be required to affirm that they accept the documented condition of the property by signing the standardized form. Upon returning the car, the standardized paper form may be retrieved and the car may again be inspected. The condition of the car, as returned, may be compared to the condition indicated on the standardized form. The renter may be liable for any damage to the car that was not initially indicated on the standardized form.

Today mobile devices are ubiquitous. Many individuals, including renters, have access to mobile devices including capabilities to capture photographs and/or video of a scene. Additionally, many of these mobile devices are networked mobile devices and include the capability to share captured photographs and/or video with other users, or to upload the captured data to cloud devices by employing network connections. Accordingly, some of the various embodiments of the current invention are directed towards documenting the condition of real and/or personal property that is loaned, leased, borrowed, or placed in the trust of another person, based on at least employing the imaging capabilities of mobile and other network devices.

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

The term “property” as used herein may include any tangible property, such as real and/or personal property. Non-limiting and non-exhaustive examples of real property include apartments, condominiums, townhomes, multi-unit homes, single family homes, hotel rooms, commercial buildings, retail space, and the like. Non-limiting and non-exhaustive examples of personal property include cars, trucks, motorcycles, other automobiles, jet skis, construction equipment, office equipment, and the like.

The term “image data” as used herein may include any data that enables a device to generate at least one visual representation of a scene or a plurality of scenes. Image data may include digital image data. In at least one embodiment, image data may include a single image. In other embodiments, image data may include a plurality of images. In some embodiments, image data may include video data. In some embodiments, image data may include both still image data and video data. Image data may include audio data. In at least one embodiment, image data may include metadata.

The following briefly describes embodiments in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed towards providing at least one of a system, a method, or an apparatus for assessing the condition of personal and/or real property that is loaned, leased, borrowed, or placed in the trust of another person. In at least one embodiment, a user may employ a client device, such as a mobile device, to document a first condition of the property to be loaned, leased, borrowed, or placed in the trust of a person. In at least one of the various embodiments, the condition may be documented by at least capturing, acquiring and/or providing documenting data. In at least one embodiment, the first condition may be the condition of the property at the time possession of the property is transferred to a first party, such as a renter, borrower, lessee, or other such other person.

In at least one embodiment, damage, destruction, alterations, and/or modifications to the property that occurred during a time period that the first party had possession of the property may be determined. In at least one embodiment, determining the damage, destruction, alterations and/or modifications may be based on the documented first condition, including the documenting data.

In at least one of the various embodiments, the mobile device employed to document the condition may include a special purpose computing device with embedded firmware or hardware. In at least one embodiment, a mobile device may include a smart phone, tablet device, or other computing device running a specialized application.

In at least one embodiment, a second condition of the property may be documented. In at least one of the various embodiments, the second condition may be subsequent to the first condition. In at least one of the various embodiments, the second condition may be the condition of the property at a later time, such as when the first party transfers possession of the property to a second party. Such second parties may include rental agencies or owners of the property.

In at least one embodiment, a variance between the first condition and the second condition may be determined. In at least one of the various embodiments, determining the damage, destruction, alterations and/or modifications that occurred during the time period that the first party had possession of the property may be determined based on at least the determined variance. In at least one embodiment, the variance may be based on the documented first condition, including the documenting data. In at least one embodiment, the variance may be based on the documented second condition, including the documenting data. In at least one embodiment, the variance may be based on a comparison of the data documenting the first condition to the data documenting the second condition. In some embodiments, determining the damage, destruction, alterations and/or modifications may be based on a comparison of the data documenting the first condition to the data documenting the second condition.

In at least one embodiment, the condition of the property may be documented by employing the client device to capture, acquire, and/or provide the documenting data. Documenting data may include image data, such as video data or still image data. In at least one of the various embodiments, the image data may be image data of at least a portion of the visually inspectable areas of the property to be loaned, leased, borrowed, or the like. In at least one embodiment, the image data may be captured by employing at least an image sensor device, or camera, included with the mobile device running the specialized application. In at least one embodiment, the image data, including audio data, may be captured by employing at least a microphone included with the mobile device.

In at least one embodiment, documenting data may include annotations of the image data, such as text, audio recordings, overlay graphics such as drawings, or additional image data. In at least one embodiment, documenting data may include at least one of a unique property identifier, a record associated with the property, authentication data, time stamp data, geo-tag data, and the like. In at least one embodiment, documenting data may include metadata associated with the image data.

For example, during a rental car check-in process, a renter may capture image data, such as still images or video, from various viewing points of the rental car. The renter may walk around the perimeter of the car in order to capture the image data from the various view points. In at least one embodiment, enough image data may be captured over a plurality of viewing angles to adequately document the condition of the car, including at least any pre-existing visible damage to the car. Likewise, a renter may capture image data of an apartment unit before the renter moves in.

In at least one embodiment, documenting data, including at least the captured image data may be provided to a server device, such as a cloud server. In at least one of the various embodiments, the documented data may be provided to a server device before the renter finishes a rental check-in process. The documenting data may be stored and/or archived on the server device for subsequent retrieval or access.

In at least one embodiment, a rental agency, or other party, may have access to the documenting data. In at least one embodiment, in order to complete the rental check-in process, and before the possession of the rental property may be transferred, verification that adequate documentation data has been provided to the server device may be required. In at least one of the various embodiments, the rental agency may not have access to the documenting data provided to the server device, unless the renter provides affirmative permission for the rental agency to access the data. In at least one of the various embodiments, the rental agency may have access to a verification notification that adequate documentation data has been provided to the server device.

In at least one embodiment, the renting party may be a user of the mobile device. In at least one embodiment, the specialized application may be a lessee version of the application. In some embodiments, a lessee version of the specialized application may provide features to the client device, such as options to obtain services. Obtainable services may include, but are not limited to insurance or damage waivers. In at least one embodiment, a lessee version of the specialized application may provide the client device with instructions on how to best use the specialized application, in conjunction with the mobile device. Such provided instructions may include instructions on how to document the condition of the property to best protect the renting party from inappropriate damage liability. In at least one embodiment, composition feedback may be provided to the client device to assist with the capturing of image data. In at least one embodiment, a lessor version of the application may be provided.

In an alternative embodiment, an employee or other agent of a rental agency may be a user of the mobile device employed to document the condition of the property. In at least one embodiment, at least one or both parties may be required to authenticate the documenting data. In at least one embodiment, authenticating the documenting data may include activating an option included in the specialized application that indicates that the authenticating party was present while the condition of the property was documented. In at least one of the various embodiments, activating an option included in the specialized application may indicate that the authenticating party accepts the condition of the property at the time that possession of the property was transferred.

In at least one of the various embodiments, the specialized application may enable user accounts and the association of data, including documenting data, with user accounts. In at least one embodiment, users may be enabled to share associated data, with other user accounts or group user accounts. In some embodiments, the data may be shared with at least a claim management service. In at least one embodiment, the documenting data may be used to assist in insurance claim collections. In at least one embodiment, the documenting data may be used to generate or cross reference contracts, or to determine compliance with check in or documenting procedures.

### Generalized Operation

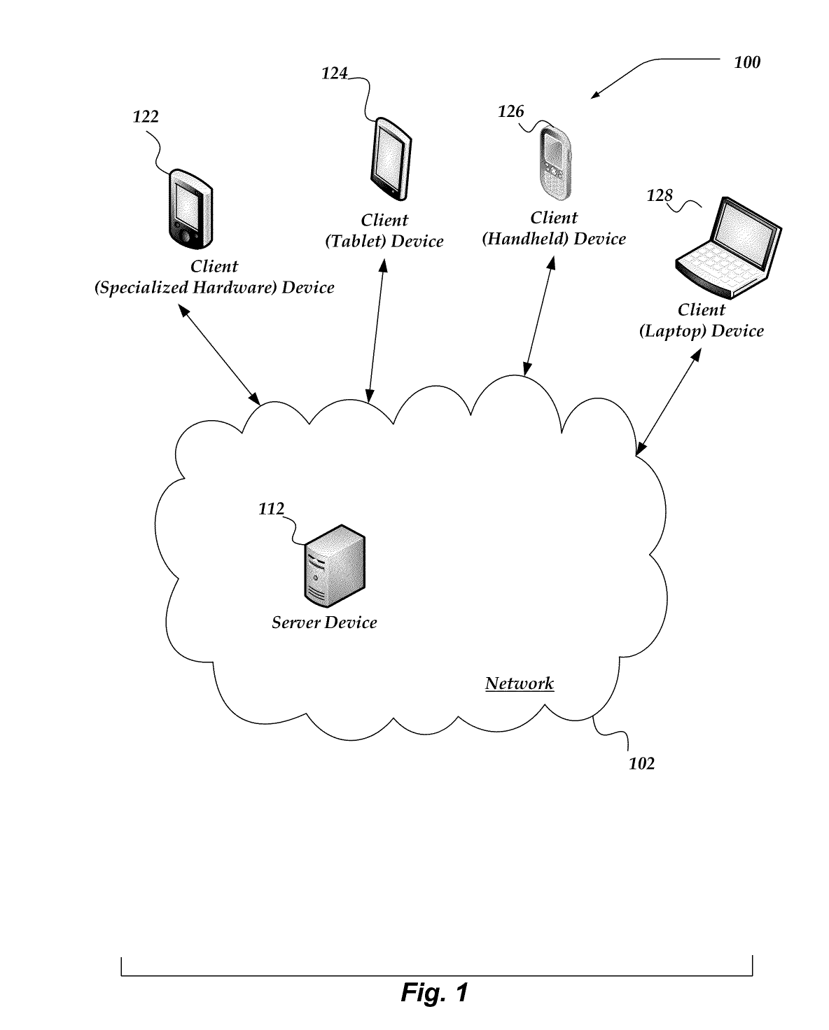

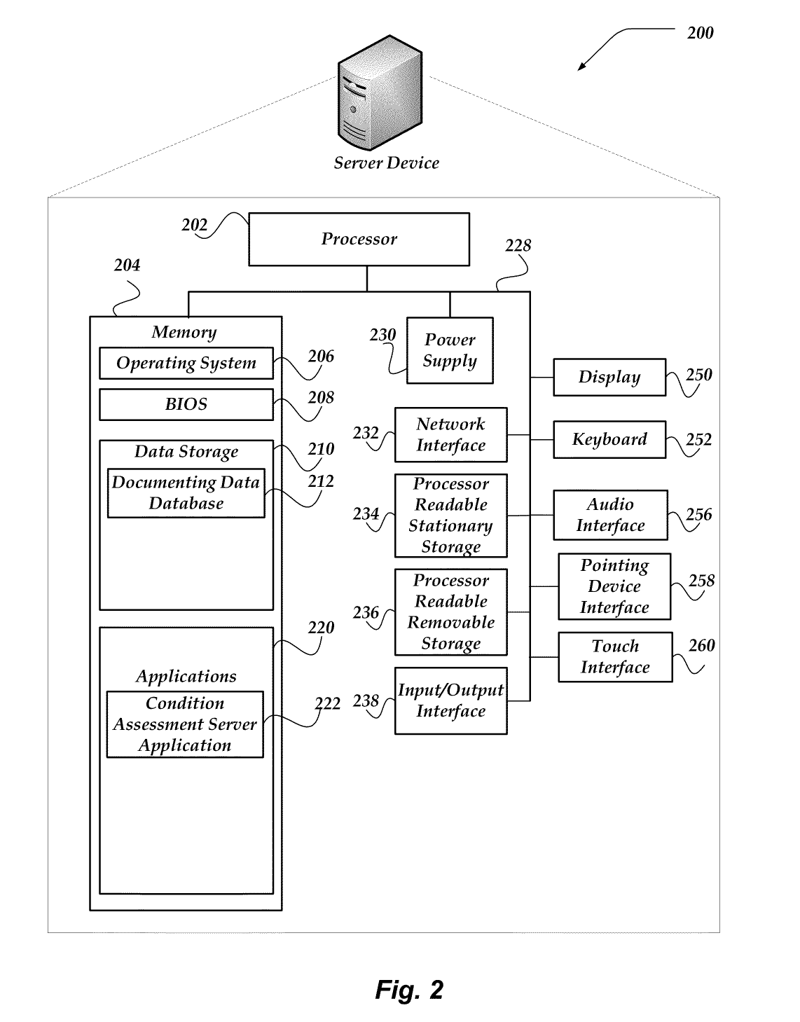

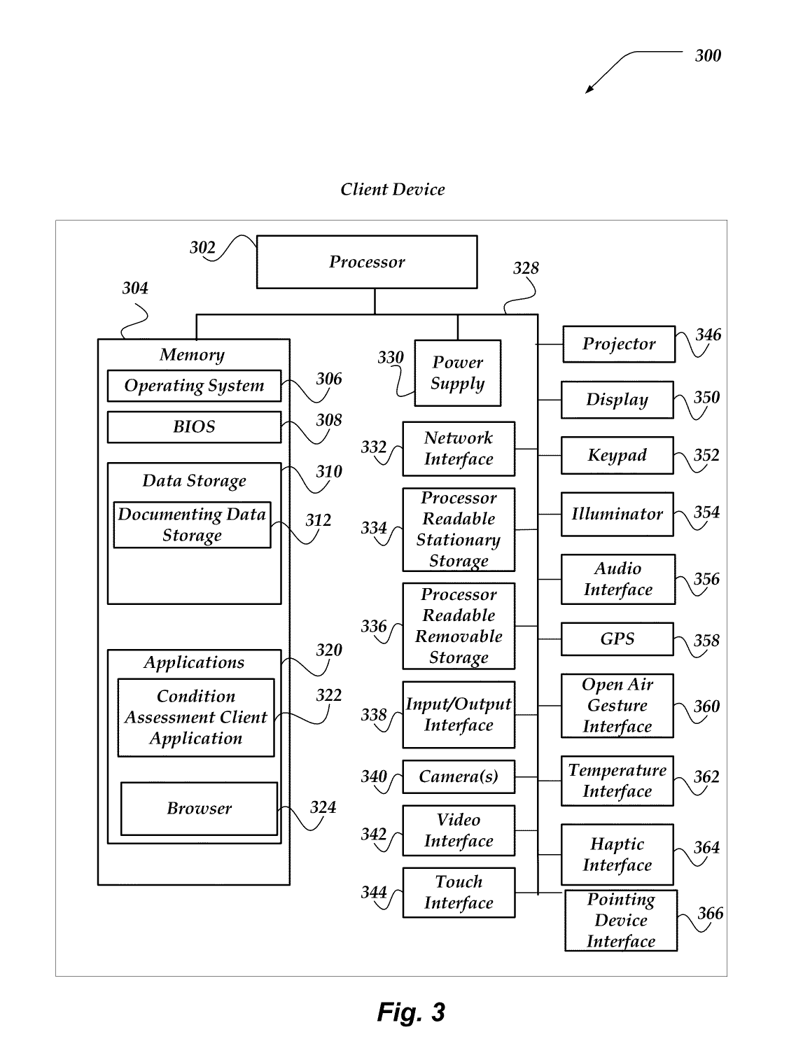

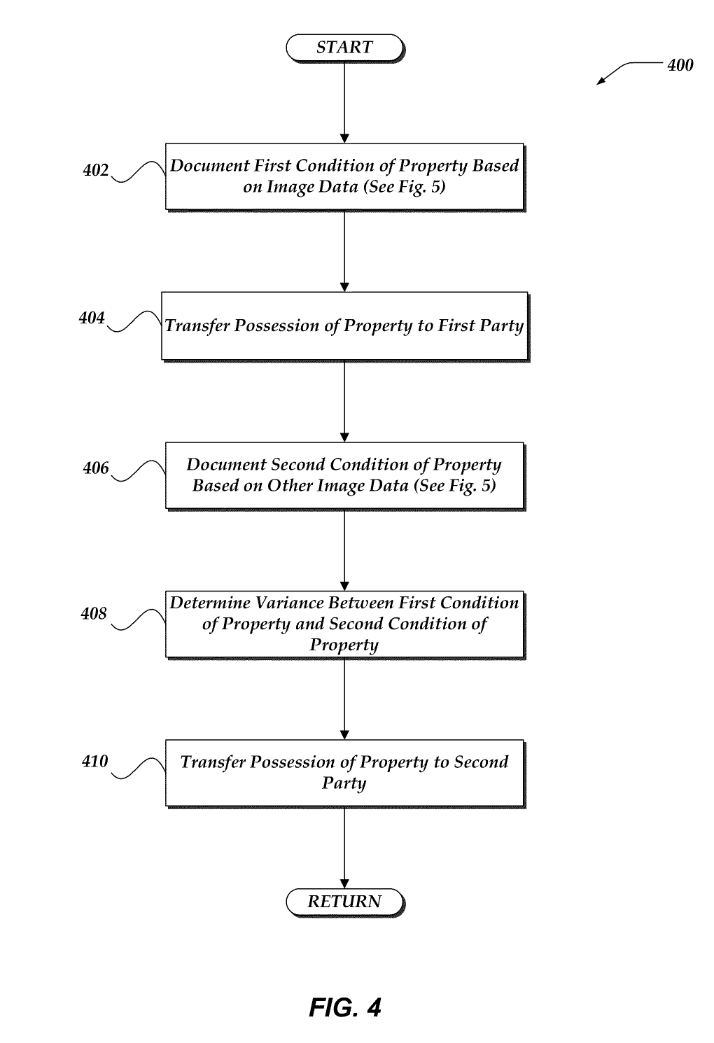

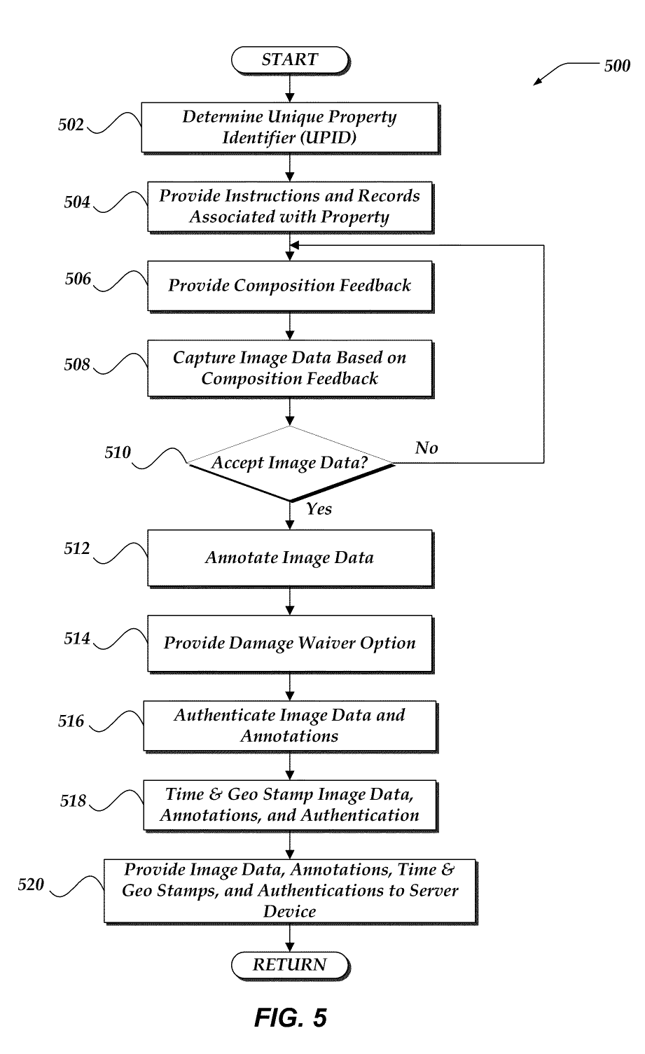

The operation of certain aspects of the invention will now be described with respect to FIGS. 4-5. FIG. 4 illustrates a logical flow diagram generally showing one embodiment of an overview process for assessing the condition of property that is transferred to a first party and subsequently transferred to a second party. In some embodiments, process 400 or portions of process 400 of FIG. 4 may be implemented by and/or executed on one or more client devices, such as client device 300 of FIG. 3. In at least one embodiment, process 400 or portions of process 400 of FIG. 4 may be implemented by and/or executed on a combination of one or more server devices, such as server device 200 of FIG. 2 and a combination of one or more client devices, such as client device 200 of FIG. 3. However, embodiments are not so limited and various combinations of server devices, such as server device 112 of FIG. 1 and client devices, such as client devices 122-128 of FIG. 1, or the like may be utilized.

Process 400 begins, after a start block, at block 402, where a first condition of property may be documented. In at least one embodiment, documenting the first condition may be based on documenting data, including at least image data. Block 402 is described in more details with regard to FIG. 5. However, briefly stated, at block 402, the first condition of the property may be documented by capturing at least image data. In at least one embodiment, the image data may be captured by employing a client device, such client device 300 of FIG. 3. In at least one of the various embodiments, the image data may be captured by employing a plurality of client devices.

In at least one embodiment, data documenting the first condition of the property may be provided to a server device, such as server device 200 of FIG. 2. In at least one of the various embodiments, the documenting data of the first condition may be stored and/or archived on the server device for subsequent access or retrieval. In at least one of the various embodiments, the documenting data may be provided to the server device, through a network connection, such as network 102 of FIG. 1.

In some embodiments, a confirmation that the documenting data was successfully provided to the server device may be provided to at least the client device. In at least one embodiment, at least one other confirmation may be provided to the at least the client device. In at least one embodiment, the at least one client device includes a client device employed to capture at least the image data. The at least one other confirmation may indicate that the documenting data satisfies documenting data requirements. In at least one embodiment, documenting data requirements may include at least image data requirements. In at least one of the various embodiments, at least one of the confirmations may be included in at least one of a text message, email message, mobile notification, or other such mechanisms.

At block 404, possession of the property may be transferred to a first party. In at least one embodiment, the first condition of the property documented in block 402 may be an ex-ante condition, or a “before condition”, of the property before or at the time that possession of the property is transferred to the first party. The documented first condition of the property may be employed to ensure accountability and/or liability for any damage, destruction, alteration, or modification to the property occurring after possession of the property has been transferred to the first party.

In at least one of the various embodiments, the first party may not hold title to the property after possession of the property has been transferred to the first party. In at least one embodiment, possession of the property may be transferred to the first party with the intent to rent, lease, loan, or otherwise place the property in the trust of the first party. In at least one embodiment, the first party may include an individual. In at least one of the various embodiments, the first party may be an entity, such as a corporation or partnership. The first party may be at least one of a renter, lessee, borrowee, lendee, bailee, trustee, and the like.

In at least one of the various embodiments, the property may be in the possession of another party before it is transferred to the first party. The other party may hold title to the property before the property is transferred to the first party. In at least one of the various embodiments, the other party may hold title to the property after the property is transferred to the first party. In at least one embodiment, the other party may be an agent of a party that holds title to the property. In an alternative embodiment, the title to the property may be transferred along with possession of the property to the first party at block 404.

In at least one embodiment, the transfer of possession of the property to the first party occurs after the first condition of the property is documented at block 402. In some embodiments, the transfer of possession of the property to the first party occurs before the first condition of the property is documented. In at least one of the various embodiments, the transfer of possession of the property to the first party occurs during a period when the first condition of the property is being documented.

In at least one embodiment, the first party may be a user of the client device that is employed to capture the image data to document the first condition of the property at block 402. In another embodiment, the other party with possession of the property before the property is transferred to the first party may be a user of the client device that is employed to capture image data to document the first condition of the property. In at least one embodiment, both the first party and the other party may be users of the client device that is employed to capture image data to document the first condition of the property.

For example, one embodiment of the present invention may be directed towards car rentals. In at least one embodiment, the first party may be a renter. In at least one such embodiment, while in proximity of the car to be rented, an individual renter may login to a pre-established user account. Logging into the user account may be accomplished by employing a specialized application installed on a client device, such as the renter's smartphone or tablet. In at least one embodiment, the specialized application may be a lessor version of the application. In at least one of the various embodiments, the user account may be a user account associated with a second party, where the second party may have had possession of the property prior to the possession being transferred to the first party. In at least one embodiment, the second party may be a rental agency. In some embodiments, the specialized application may be a lessee version of the application. In some embodiments, the user account may be associated with a third party.

After establishing a secure login session, the renter may use the specialized application in conjunction with a camera device included in the renter's smart phone or tablet to capture image data, such as still images and/or video of the rental car. The captured images and/or video may document the condition of the rental car before the renter takes possession of the car. The renter may photograph the rental car from a plurality of relevant viewing angles in order to document the first condition of the car, including any visual damage associated with the rental car. The renter may walk around the perimeter of the car to capture image data from the plurality of viewing angles. In at least one embodiment, the renter may capture video of the car. For example, the renter may photograph and/or video scratches in the rental car's driver side door. It will be understood that the invention is not limited to car rental, but may be directed towards at least the rental of any property, including real property. For instance, a renter may similarly document the condition of an apartment before moving in.

In at least one embodiment, the captured image data, and any other data documenting the first condition of the rental car may be provided to a server device. In at least one embodiment, the provided documenting data may be associated with at least the renter's user account. After receiving confirmation that the documenting data was successfully provided to the server and the documenting data satisfies at least documenting data requirements, the renter may proceed by taking possession of the rental car, including driving the rental car off the car rental agency's lot.

In at least one embodiment, the renter's user account may be associated with at least one other user account or user group accounts. In some embodiments, the renter's user account may be enabled to share data associated with the renter's user account, including any data documenting a condition of the property, with other user accounts or group accounts. Users with whom data is shared may be enabled to subsequently access or retrieve the shared data. In at least one of the various embodiments, users with whom data is shared may access or retrieve the shared data by employing a specialized mobile or desktop application, through a standard web browser, or any other typical manner. In at least one embodiment, the renter may be able to access or retrieve any data associated with the renter's user account at least during or after the rental period. In some embodiments, users with whom documenting data may be shared include insurance management services. Insurance management services may use the shared documenting data to assist in future claims collections processes.

It will be understood that the present invention is not limited to the rental of person and/or real property, but may be directed towards any scenario that the possession of property is transferred. Some embodiments are directed towards documenting the condition of property before, during, and after the property is at least freighted, shipped, or otherwise transported. At least one embodiment is directed towards generating shipping documentation.

At any rate, process 400 flows to block 406, where a second condition of the property may be documented. In at least one embodiment, documenting the second condition may based on documenting data, including at least image data. Documenting the second condition may involve similar steps as the steps involved with documenting the first condition of the property. As such, details of block 406 are described with regard to FIG. 5. However, briefly stated, at block 406 the second condition of the property may be documented by capturing at least image data separate from the image data captured during the documenting the first condition of the property at block 402.

In at least one embodiment, the image data captured at block 406 may be captured with the same client device or special purpose computing device may be employed to capture image data while documenting the first condition of the property. In an alternative embodiment, another separate client device or special purpose computing device may be employed to capture image data at block 406, rather than the client device or special purpose computing device employed to document the first condition of the property. In at least one embodiment, at least the documenting data documenting the second condition of the property may be provided to a server device, so that the second condition may be stored or archived for retrieval at a later time.

In at least one embodiment, the second condition of the property may be documented in block 408 to establish an ex post facto condition, or an “after condition”, of the property after the first party has been in possession of the property for an amount of time.

For instance, again in the context of car rentals, when the renter returns the rental car to the car rental agency, the renter may again login to their account. The renter may capture pictures or video to document the condition of the rental car after the rental period has expired. To document the second condition, the renter may photograph the rental car in a manner similar to how the rental car was photographed to document the first condition. In at least one embodiment, the renter may upload the documenting data and associate the documenting data with their account in a manner similar to the data documenting the first conditions. Furthermore, the renter, as well as other users, may access or retrieve the data documenting the second condition in a similar manner.

At block 408, at least one variance between the first condition of the property and the second condition of the property may be determined. In at least one embodiment, the determined variance may be based on at least the data documenting the first condition of the property. In at least one of the various embodiments, the determined variance may be based on at least the data documenting the second condition of the property. In at least one embodiment, the determined variance may be based on at least a comparison between the data documenting the first condition of the property and the second condition of the property. In at least one embodiment, the determined variance may be based on at least a comparison between the data documenting the first condition of the property and the data documenting the second condition of the property.

In some embodiments, the data documenting the first condition may be retrieved and/or accessed. In some embodiments, the data documenting the second condition may be retrieved and/or accessed. In at least one embodiment, at least a portion of the comparison between the documented first condition and the second condition may me performed by employing a client device to display at least a portion of the data documenting the first condition. In at least one embodiment, at least a portion of the comparison between the documented first condition and the second condition may me performed by employing a client device to display at least a portion of the data documenting the second condition. In at least one embodiment, a server device may be employed to display at least a portion of the documenting data.

In at least one embodiment, at least a portion of the variance between the first condition and the second condition may be determined by an automatic comparison of documenting data. In at least one of the various embodiments, at least a portion of the variance between the first condition and the second condition may be determined by a manual comparison of documenting data. In at least one embodiment, at least one party may be required to authenticate, or otherwise validate the determined variance.

In at least one of the various embodiments, a fee to charge the first party may be determined. In at least one embodiment, the determination of the fee to charge the first party may be based, at least on the determined variance between the first condition and the second condition. In at least one embodiment, a record of the determined variance between the first condition and the second condition may be generated. The generated variance record may be provided to at least a server device.

In an alternative embodiment, a second condition may not be documented with a process such as process 500 of FIG. 5. In such embodiments, the variance between the first condition and the second condition may be determined by at least manually comparing the data documenting the first condition to a visual inspection of the property.

At block 410, possession of the property is transferred to a second party. In at least one embodiment, the second party may be a party who had possession of the property prior to the possession of the property being transferred to the first party at block 404. In at least one of the various embodiments, the second party may hold title to the property before possession of the property is transferred to the second party. In some embodiments, the second party may hold title to the property after possession of the property has been transferred to the second party. In at least one embodiment, the second party may have never previously taken possession of the property.

In at least one embodiment, the transfer of possession of property to the second party occurs after the second condition of the property is documented at block 406. In some embodiments, the transfer of possession of property to the second party occurs before the second condition of the property is documented. In at least one of the various embodiments, the transfer of possession of property to the second party occurs during a period when the second condition of the property is being documented.

In at least one embodiment, the transfer of possession of property to the second party occurs after the variance between the first condition and second condition of the property is determined at block 408. In some embodiments, the transfer of possession of property to the second party occurs before after the first and second conditions of the property are compared. In at least one of the various embodiments, the transfer of possession of property to the second party occurs during a period when after the first and second conditions of the property are being compared.

FIG. 5 illustrates a logical flow diagram generally showing one embodiment of a process for documenting a condition of property based on image data. In some embodiments, process 500 or portions of process 500 of FIG. 5 may be implemented by and/or executed on one or more client devices, such as client device 300 of FIG. 3. In at least one embodiment, process 500 or portions of process 500 of FIG. 5 may be implemented by and/or executed on a combination of one or more server devices, such as server device 200 of FIG. 2 and a combination of one or more client devices, such as client device 200 of FIG. 3. However, embodiments are not so limited and various combinations of server devices, such as server device 112 of FIG. 1 and client devices, such as client devices 122-128 of FIG. 1, or the like may be utilized.

Process 500 begins, after a start block, at block 502, where a unique property identifier (UPID) may be determined. The UPID may be uniquely associated with the property to be documented. The UPID may uniquely identify the particular property to be documented. In at least one embodiment, the UPID may be an identification number, such as a Vehicle Identification Number (VIN), a license tag, or other such unique number or string of alpha-numeric characters. In some embodiments, the UPID may be a digital identifier, such as a traditional barcode, a matrix barcode, such as a Quick Response Code (QR code), or some other machine readable representation of data that uniquely identifies the property. In some embodiments, the UPID may include a street address, or other identifying data associated with real property.

In at least one of the various embodiments, the UPID may be determined by at least employing sensors included in a client device, such as client device 300 of FIG. 3. For instance, a camera included in the client device may be employed to read a QR code associated with the property. In some embodiments, employing a camera in conjunction with at least an Optical Character Recognition (OCR) application may be used to determine the UPID, such as a VIN, and address, or other string of alpha-numeric characters. In another embodiment, a user may manually enter the UPID into the client device, through a keypad or other such input device. In at least one embodiment, a user may enter the UPID into the client device by audibly dictating UPID information, such as reading a VIN number associated with the property, into the device and employing voice recognition software. In at least one embodiment, the determined UPID may be provided to a server device at block 502.

Process 500 proceeds to block 504, where instructions for documenting a condition of the property may be provided to the client device. In at least one embodiment, the provided instructions may detail things to look for while capturing image data and how to best protect the user from inappropriate damage liability. In at least one of the various embodiments, the provided instructions may be based on whether a renter or lessee is taking possession of the rental property or returning the rental property.

In at least one embodiment, the provided instructions may be based on the type of property to be documented. In at least one of the various embodiments, the provided instructions may be based on at least the UPID determined at block 502. In at least one embodiment, the instructions may include video or other image data.

In at least one embodiment, at least one record associated with the property may be provided to the client device at block 504. In at least one embodiment, the provided record may include at least a previously determined condition of the property. In at least one embodiment, the provided record may include at least a previously determined variance between at least two previous conditions of the property. In at least one of the various embodiments, the provided record includes at least image data. In some embodiments, the provided record includes data documenting at least a prior condition of the property. Such documenting data may include damage reports, image data of damage to the property, history reports of the property, and the like. In at least one embodiment, the provided instructions may be based on at least one record associated with the property, such as the record provided to the client device. In at least one embodiment, the provided instructions may be based on at least a previously determined condition of the property. In some embodiments, the provided instructions may be based on at least a previously determined variance between at least two previous conditions of the property.

For instance, at least one “how to” video may be provided to the documenting client device. A “how to” video may include instructions on how to best use the specialized application to capture image data to adequately document the condition of the property. A provided “how to” video may direct the user to capture image data of specific areas of the property due to previously known damage, such as known scratches in a rental car or apartment unit.

In at least one of the various embodiments, a “how to” video may provide a comprehensive list of the image data set required to adequately document a condition of the property. In at least one embodiment, the comprehensive list may include at least documenting data requirements, including image data requirements. Documenting data requirements may be displayed at the client device in a checklist format. In at least one embodiment, a user may be enabled to check off documenting data requirements as the user captures documenting data.

In some embodiments, the provided video may direct a user to portions of, or sections of the property that are known to be particularly prone to, or sensitive to damage. For example, in the context of car rentals, the video may instruct a user to capture image data of the driver's side door, because rental cars tend to develop scratches in the driver side doors during rental periods. In the context of rental apartments, a video may instruct the user to capture image data of a living room wall, because living room walls tend to develop blemishes during rental periods. It will be understood that invention is not so limited to “how to” videos and the instructions may be provided in any format, including text, audio, still pictures, and the like.

At any rate, process 500 proceeds to block 506, where composition feedback may be provided to the client device. Such composition feedback may include instructions or indications on how to capture image data to adequately document a condition of the property. In at least one embodiment, the composition feedback may be based on sensor data captured by the client device, such as image data. In at least one embodiment, the provided composition feedback may be real time feedback. In at least one of the various embodiments, the composition feedback may be adjusted or modified based on image data captured by the client device. In some embodiments, the adjustment or modification of the composition feedback may be provided in real time.

For instance, the provided composition feedback may instruct a user to stand at an appropriate distance from the property to be documented. In at least one embodiment, the composition feedback may instruct a user to stand at an appropriate position and/or location, with respect to the property to be documented. In at least one embodiment, a determination may be made, based at least on image data captured by the client device, whether the user is standing in an appropriate position, location, and/or distance from the property. If the user's position, location, and/or distance is not appropriate, the composition feedback may, in real time, direct the user to the appropriate distance, location, and/or position. In at least one of the various embodiments, the real time composition feedback may inform the user if image data requirements to adequately document the condition of the property have been satisfied.

In at least one embodiment, at least a portion the composition feedback may be displayed on a display screen included on the mobile device. In at least one embodiment, the display screen may simultaneously display images or video of the property and a portion of the composition feedback. In at least one embodiment, the displayed portion of the composition feedback may be blended, or composited with displayed image data of the property. In at least one embodiment, the displayed portion of the composition feedback may be transparent or translucent. In some embodiments, the displayed portion of the composition feedback may include at least a frame, or outline of the property, to assist the user in capturing image data to adequately document the condition of the property. In at least one of the various embodiments, the composition feedback may be displayed in the form of crosshairs, textual instructions, or other such markings on the display screen. Displayed crosshairs may be employed by the user to capture image data to adequately document the condition of the property. In at least one of the various embodiments, the composition feedback may be based at least on the viewing angle. If the user is capturing image data from a front angle of a car, for instance, an approximate outline of a front view of the car may be displayed on the mobile device. The user may employ the outline to insure that the car is approximately enclosed in the frame. As the user traverses around the car, the outline may be updated in real time to correspond with the user's viewing angle. In at least one embodiment, the composition feedback may include audio commands issued by the mobile device.

At block 508, image data may be captured to document the condition of the property. In at least one embodiment, capturing the image data may be based on at least the composition feedback. In at least one embodiment, a plurality of image frames may be captured, from at least one viewing angle of the property. In at least one of the various embodiments, at least one frame may be captured for a plurality of viewing angles. In some embodiments, a plurality of captured image data frames may provide a visual representation for a substantial portion of the property. For instance, a user may walk around a rental car, while taking image data frames from a plurality of view points. In some embodiments, video image data may be captured as the user traverses the property. In at least one embodiment, the real time composition feedback may direct a user as to the location, position, and/or distance as they walk around the property.

At decision block 510, a determination may be made whether to accept the image data captured at block 510. In at least one embodiment, this determination may be based on a determination if the captured image data adequately satisfies the image data requirements to document at least a condition of the property. This determination may be based on the captured image data and the image data requirements. In at least one of the various embodiments, this determination may be based on the composition feedback. In at least one embodiment, image data requirements may be based on the type of property being documented. In at least one of the various embodiments, image data requirements may be based on the UPID determined at block 502. In some embodiments, the image data requirements may be provided in the instructions provided at block 504. At any rate, if the image data is not accepted, then process 500 may flow back to block 506. Otherwise, process 500 may flow to block 512.

In at least one embodiment, image data requirements may include the requirement to adequately document at least portions of the property that are predetermined to be sensitive to damage. In at least one embodiment, image data requirements may include the requirement to adequately document at least portions of the property where damage has been previously detected. In at least one of the various embodiments, image data requirements may include a total number of image frames, a total coverage of the property by the captured image data, at least one captured image frame for each view point in a set of required view points, a quality assurance metric for a threshold number of captured frames, and the like.

At block 512, a user may be given the option to annotate the captured image data. In at least one embodiment, annotating the image data may include adding notations to the image data. In at least one embodiment, annotations and/or notations may include text, audio, or other separate image data. In at least one of the various embodiments, the client device may be employed to annotate the image data, such as typed notations, recording audio notes, or capturing additional image data.

In at least one embodiment, the image data may be displayed at the client device as the user annotates the image data. For instance, if the documenting image data includes video data, the user may re-play the video after it is captured. In at least one embodiment, a user may pause the video and provide annotations. For example, a user may pause a recorded video to annotate the image data by using their fingers on a client device touch sensitive screen, where the screen is displaying the image data. By using their fingers on the touch sensitive screen, marks that overlay the video may be generated. In at least one embodiment, a user may draw directly on the paused video or still images to highlight sections of the property, such as damaged sections. In at least one embodiment, a user may draw or directly write onto a visual representation of the image data, such that the visual representation of the image data acts as a virtual chalkboard.

The user may annotate the image data with “Touch Notation” tags or overlays. “Touch Notation” overlays enable a user to associate a tag or keyword to a specific portion or region of the image data. The keyword may be indicative of a condition of the property at the region corresponding to the specific portion of the image data. In preferred embodiments, the “Touch Notation” overlay is simultaneously displayed on the screen, overlaying or blending with the image data to provide a visual indication where the user is associating the keyword or tag with the condition of the property.

“Touch Notation” tags or overlays may be predefined tags. The user may indicate the specific region by touching the screen in the region that displays the portion of the image data to be tagged by the “Touch Notation.” The tags may be user-specific and defined by the user or another party. The tags may also be specific to the type of property being documented. Exemplary “Touch Notation” keywords for vehicles may include “Dent,” “Scratch,” “Paintless Dent Repair,” and the like. Other “Touch Notation” overlays may be similarly defined for other property types, such as apartment rentals. In at least one embodiment, the user is enabled to define new “Touch Notations” corresponding to new keywords when annotating image data. The ability to define in “Touch Notations” in real time when documenting property is useful when the user encounters an unanticipated condition of the property, a new property type, or the user wishes to make a notation regarding the property.

Although “Touch Notations” are discussed in the context of keywords, it should be notated that “Touch Notations” are not limited to keywords. Rather, any alpha-numeric character string, including sentences, paragraphs, and the like may be associated with “Touch Notations.” When characters strings longer than a predefined character length are associated with a “Touch Notation” are selected, to limit crowding on the screen and for aesthetic purposes, only a sub-portion of the character string may be displayed on the screen when the “Touch Notation” is overlaid on the image data. The user may select the particular “Touch Notation” from a “Touch Notation” menu or other component on the GUI. The GUI enables the selection of the particular “Touch Notation” from a plurality of available “Touch Notations.” In addition to pausing the recorded video, in preferred embodiments, the user may annotate the image data, using any of the annotation tools or techniques discussed herein, including “Touch Notations,” in real-time or near real-time during the capturing of the image data.

In at least one of the various embodiments, a user may provide, in real-time or during a review of the image data, other notations for the image data using any of the capabilities provided by the client device. In some embodiments, the user may be enabled to pull up a notes window where the user may manually enter notations. In at least one embodiment, voice recognition software may be used to transcribe dictated notes to text notes. In at least one embodiment, annotations may be provided in real time as the image data is being captured. For instance, a user may pause the recording of video, in order to provide annotations. In some embodiments, annotations may include tagging the image data with keywords or other tags. In at least one embodiment, a user may annotate the image data by providing various metadata to be associated with the image data.

In some embodiments, process 500 proceeds to block 514. At block 514, an option to obtain various products may be provided to the client device. The options for various products may include insurance options, such as damage waivers. In some embodiments, the various products may include additional services, such as to pre-pay for a tank of gas or an option to pre-pay a cleaning fee when the renter moves out of an apartment. For instance, when a first condition of the property to be leased or rented is being documented, the client device may be provided with an option to purchase a damage waiver, where a user can choose to exercise the option.

At block 516, the documenting data may be authenticated. In at least one embodiment, documenting data includes at least the image date. In at least one embodiment, the documenting data includes at least the annotation data provided at block 512. In some embodiments, authenticating the documenting data indicates that an authenticating party, such as either a first or second party agrees that the documenting data adequately documents the condition of the property at the time possession of the property is exchanged. In at least one of the various embodiments, the documenting data may be authenticated by at least a party activating an option on the client device, or other means of electronically confirming that they were present and accept the condition of the property at the time the possession of the property was transferred. In at least one embodiment, the party with possession of the property before it is transferred may authenticate the documenting data. In at least one of the various embodiments, the party who is taking possession of the property may authenticate the documenting data. In at least one embodiment, both parties may be required to authenticate the documenting data. before possession of the property may be transferred.

At block 518, the each piece of documenting data may be independently time stamped and various metadata may be generated or provided. A time stamp may include a date and a time that each piece of the documenting data was acquired, captured, and/or provided. In at least one embodiment, metadata such as client device user, camera parameters settings, a client device unique address, a version number of the specialized application, and the like, may be generated and provided to the documenting data at block 518. In at least one embodiment, the documenting data may be geo-tagged to include a global location where the documenting data, including the image data was captured. Accordingly, at block 518, each piece of documenting data may be independently geo-tagged and/or geo-stamped, so that the date, time, and global location corresponding to the where and when that the documenting data was captured becomes part of the documenting data stream. Process 500 next flows to block 520, where the documenting data, including the image data, annotation data, authenticating data, and the time and geo stamp data may be provided to a server device, such as server device 200 of FIG. 2.

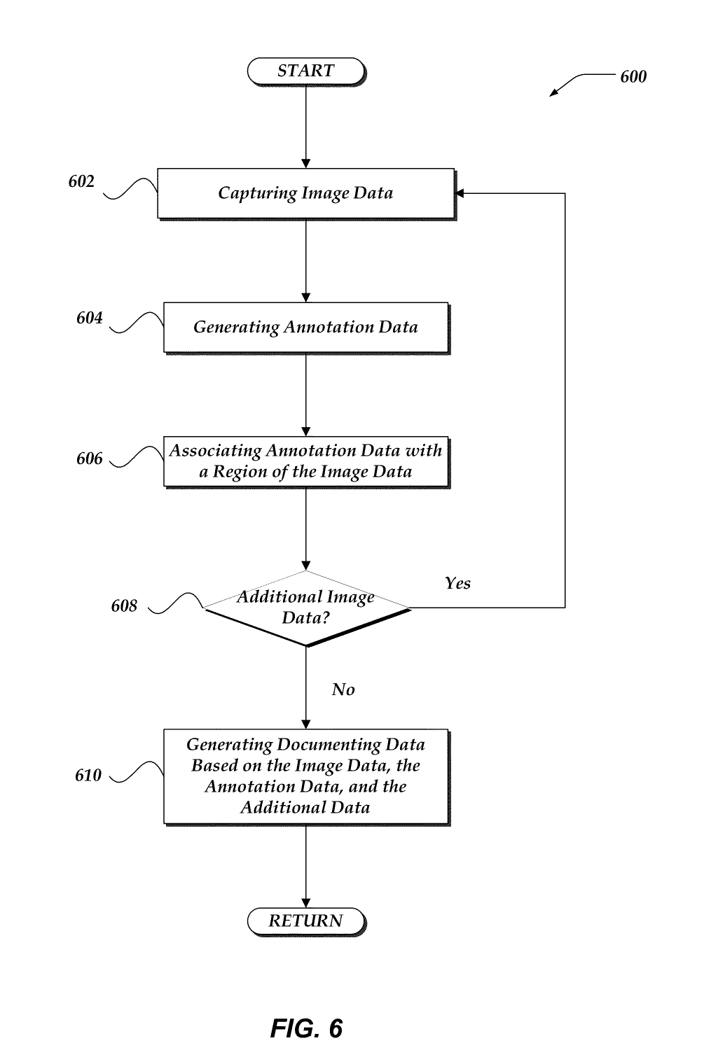

FIG. 6 illustrates a logical flow diagram generally showing another embodiment of a process for documenting a condition of property based on image data. In some embodiments, process 600 or portions of process 600 of FIG. 6 may be implemented by and/or executed on one or more client devices, such as client device 300 of FIG. 3. In at least one embodiment, process 600 or portions of process 600 of FIG. 6 may be implemented by and/or executed on a combination of one or more server devices, such as server device 200 of FIG. 2 and a combination of one or more client devices, such as client device 200 of FIG. 3. However, embodiments are not so limited and various combinations of server devices, such as server device 112 of FIG. 1 and client devices, such as client devices 122-128 of FIG. 1, or the like may be utilized.

Process 600 begins, after a start block, at block 602, where image data is captured. Capturing image data at block 602 may be similar to capturing image data as described herein, including at least in the context of blocks 402 or 408 of FIG. 4 or block 508 of FIG. 5. The image data includes image data of the property to be documented. At block 604, annotation data is generated. In various embodiments, a computer device, such as either a server device or a client device may generate the annotation data. Generating the annotation data may be in response to a user annotating the image data, similar to the embodiments described herein, including at least in the context of block 512 of FIG. 5. The annotation data may be based on a determined feature of the property, such as a scratch, dent, or the like.

The user may annotate the image data at any time during either process 500 of FIG. 5, process 600 of FIG. 6, or any other process described herein. Accordingly, the annotation data may be generated at any time during documenting the condition of the property. For instance, the user may annotate the image data in real or near real time while capturing image data, such as video data. Alternatively, the user may annotate the image data during a review of the captured image data. To review the image data, the user may playback video data. Controlling the playback of video data may be enabled by a progress ribbon. The user may review image data, such as a plurality of image frame, by employing a swipe feature of a touch screen of the client device or by click thru Next/Previous icons.

The annotations data may include one or more location-specific “Touch Notation” overlays and/or tags. For instance, while capturing video data, a user may touch-notate a scratch or dent on the property. The plurality of “Touch Notation” overlays may include a specific “Touch Notation” overlay that corresponds to the type of feature to be annotated. As a non-limiting exemplary embodiment, a red circle may be indicative of property damage. At block 606, at least a portion of the annotation data is associated with a region of the image data. The region of the image data may include the determined feature of the property. Continuing with the example of “Touch Notation” overlays, the user may touch a region of the screen that corresponds to the determined property damage and a region of the image data that includes the damage may be highlighted by a red circle. The user may also provide textual annotation data. The textual annotation data may be entered via a user input keyboard functionality or a speech-to-text functionality enabled by the client device. The user may also include audio annotation data, such as a recorded dictation of the condition of the property. The annotation data may be blended with the image data for simultaneous display, either in the review mode or in a real time mode during the capturing of the image data.

At decision block 608, it is determined whether additional image data is to be captured. If so, process 600 proceeds to block 602. If additional image data is not required, process 600 proceeds to block 610. As indicated above, because the user may annotate the image data in real or near real time, the user may annotate the data simultaneously while capturing additional image data. At block 610, documenting data is generated. The documenting data may be based on at least one of the image data, the annotation data, or any additional image data. The documenting data may be a blend or a combination of any data and/or metadata that provides a documentation of the property. The documenting data documents a first condition of the property. As discussed herein, a second condition of the property may be documented at an earlier or later point in time. The documenting data may be based on any type of data, including the various documenting data discussed in the context of FIG. 5. Process 600 terminates at the end block.

### Illustrative Operating Environment

FIG. 1 shows components of an environment in which various embodiments may be practiced. Not all of the components may be required to practice the various embodiments, and variations in the arrangement and type of the components may be made without departing from the spirit or scope of the various embodiments.

In at least one embodiment, cloud network 102 enables one or more network services for a user based on the operation of corresponding arrangement of virtually any type of networked computing device. As shown, the networked computing devices may include server device 112. Although not shown, one or more client devices may be included in cloud network 102 in one or more arrangements to provide one or more network services to a user. Also, these arrangements of networked computing devices may or may not be mutually exclusive of each other.

Additionally, the user may employ a plurality of virtually any type of wired or wireless networked computing devices to communicate with cloud network 102 and access at least one of the network services enabled by one or more of arrangements, including arrangement 104. These networked computing devices may include server device 112, client device 122, tablet client device 124, handheld client device 126, laptop client device 120, and the like. Although not shown, in various embodiments, the user may also employ notebook computers, desktop computers, microprocessor-based or programmable consumer electronics, network appliances, mobile telephones, smart telephones, pagers, radio frequency (RF) devices, infrared (IR) devices, Personal Digital Assistants (PDAs), televisions, integrated devices combining at least one of the preceding devices, and the like.

One embodiment of a client device is described in more detail below in conjunction with FIG. 3. Generally, client devices may include virtually any substantially portable networked computing device capable of communicating over a wired, wireless, or some combination of wired and wireless network.

In various embodiments, network 102 may employ virtually any form of communication technology and topology. For example, network 102 can include local area networks Personal Area Networks (PANs), (LANs), Campus Area Networks (CANs), Metropolitan Area Networks (MANs) Wide Area Networks (WANs), direct communication connections, and the like, or any combination thereof. On an interconnected set of LANs, including those based on differing architectures and protocols, a router acts as a link between LANs, enabling messages to be sent from one to another. In addition, communication links within networks may include virtually any type of link, e.g., twisted wire pair lines, optical fibers, open air lasers or coaxial cable, plain old telephone service (POTS), wave guides, acoustic, full or fractional dedicated digital communication lines including T1, T2, T3, and T4, and/or other carrier and other wired media and wireless media. These carrier mechanisms may include E-carriers, Integrated Services Digital Networks (ISDNs), universal serial bus (USB) ports, Firewire ports, Thunderbolt ports, Digital Subscriber Lines (DSLs), wireless links including satellite links, or other communications links known to those skilled in the art. Moreover, these communication links may further employ any of a variety of digital signaling technologies, including without limit, for example, DS-0, DS-1, DS-2, DS-3, DS-4, OC-3, OC-12, OC-48, or the like. Furthermore, remotely located computing devices could be remotely connected to networks via a modem and a temporary communication link. In essence, network 102 may include virtually any communication technology by which information may travel between computing devices. Additionally, in the various embodiments, the communicated information may include virtually any kind of information including, but not limited to processor-readable instructions, data structures, program modules, applications, raw data, control data, archived data, video data, voice data, image data, text data, and the like.

Network 102 may be partially or entirely embodied by one or more wireless networks. A wireless network may include any of a variety of wireless sub-networks that may further overlay stand-alone ad-hoc networks, and the like. Such sub-networks may include mesh networks, Wireless LAN (WLAN) networks, Wireless Router (WR) mesh, cellular networks, pico networks, PANs, Open Air Laser networks, Microwave networks, and the like. Network 102 may further include an autonomous system of intermediate network devices such as terminals, gateways, routers, switches, firewalls, load balancers, and the like, which are coupled to wired and/or wireless communication links. These autonomous devices may be operable to move freely and randomly and organize themselves arbitrarily, such that the topology of network 102 may change rapidly.

Network 102 may further employ a plurality of wired and wireless access technologies, e.g., 2nd (2G), 3rd (3G), 4th (4G), 5^{th} (5G) generation wireless access technologies, and the like, for mobile devices. These wired and wireless access technologies may also include Global System for Mobile communication (GSM), General Packet Radio Services (GPRS), Enhanced Data GSM Environment (EDGE), Code Division Multiple Access (CDMA), Wideband Code Division Multiple Access (WCDMA), Long Term Evolution Advanced (LTE), Universal Mobile Telecommunications System (UMTS), Orthogonal frequency-division multiplexing (OFDM), Wideband Code Division Multiple Access (W-CDMA), Code Division Multiple Access 2000 (CDMA2000), Evolution-Data Optimized (EV-DO), High-Speed Downlink Packet Access (HSDPA), IEEE 802.16 Worldwide Interoperability for Microwave Access (WiMax), ultra wide band (UWB), user datagram protocol (UDP), transmission control protocol/Internet protocol (TCP/IP), any portion of the Open Systems Interconnection (OSI) model protocols, Short Message Service (SMS), Multimedia Messaging Service (MMS), Web Access Protocol (WAP), Session Initiation Protocol/Real-time Transport Protocol (SIP/RTP), or any of a variety of other wireless or wired communication protocols. In one non-limiting example, network 102 may enable a mobile device to wirelessly access a network service through a combination of several radio network access technologies such as GSM, EDGE, SMS, HSDPA, and the like.

One embodiment of server device 112 is described in more detail below in conjunction with FIG. 2. Briefly, however, server device 112 includes virtually any network device capable of providing services to a client device. In some embodiments, server device 112 may store and/archive data documenting the conditions of real and/or personal property. Devices that may be arranged to operate as server device 112 include various network devices, including, but not limited to personal computers, desktop computers, multiprocessor systems, microprocessor-based or programmable consumer electronics, network PCs, server devices, network appliances, and the like.

Although FIG. 1 illustrates server device 112 as a single computing device, the invention is not so limited. For example, one or more functions of server device 112 may be distributed across one or more distinct network devices. Moreover, server device 112 is not limited to a particular configuration. Thus, in one embodiment, server device 112 may contain a plurality of network devices. In another embodiment, server device 112 may contain a plurality of network devices that operate using a master/slave approach, where one of the plurality of network devices of server device 112 operates to manage and/or otherwise coordinate operations of the other network devices. In other embodiments, server device 112 may operate as a plurality of network devices within a cluster architecture, a peer-to-peer architecture, and/or even within a cloud architecture. Thus, the invention is not to be construed as being limited to a single environment, and other configurations, and architectures are also envisaged.

### Illustrative Server Device

FIG. 2 shows one embodiment of server device 200 that may be included in a system implementing the invention. Server device 200 may include many more or less components than those shown in FIG. 2. However, the components shown are sufficient to disclose an illustrative embodiment for practicing the present invention. Server device 200 may represent, for example, one embodiment of at least one of server device 112 of FIG. 1.

As shown in the figure, server device 200 may include a processor 202 in communication with a memory 204 via a bus 228. server device 200 may also include a power supply 230, network interface 232, audio interface 256, display 250, keyboard 252, input/output interface 238, processor-readable stationary storage device 234, processor-readable removable storage device 236, and pointing device interface 258. Power supply 230 provides power to server device 200.

Network interface 232 may include circuitry for coupling server device 200 to one or more networks, and is constructed for use with one or more communication protocols and technologies including, but not limited to, protocols and technologies that implement any portion of the Open Systems Interconnection model (OSI model), GSM, CDMA, time division multiple access (TDMA), UDP, TCP/IP, SMS, MMS, GPRS, WAP, UWB, WiMax, SIP/RTP, or any of a variety of other wired and wireless communication protocols. Network interface 232 is sometimes known as a transceiver, transceiving device, or network interface card (NIC). Server device 200 may optionally communicate with a base station (not shown), or directly with another computing device.

Audio interface 256 is arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of server device 200, for example, using voice recognition.

Display 250 may be a liquid crystal display (LCD), gas plasma, electronic ink, light emitting diode (LED), Organic LED (OLED) or any other type of light reflective or light transmissive display that can be used with a computing device. Display 250 may be a handheld projector or pico projector capable of projecting an image on a wall or other object.

Server device 200 also may also comprise input/output interface 238 for communicating with external devices not shown in FIG. 2. Input/output interface 238 can utilize one or more wired or wireless communication technologies, such as USB™, Firewire™, WiFi, WiMax, Thunderbolt™, Infrared, Bluetooth™, Zigbee™, serial port, parallel port, and the like.

Human interface components can be physically separate from server device 200, allowing for remote input and/or output to server device 200. For example, information routed as described here through human interface components such as display 250 or keyboard 252 can instead be routed through the network interface 232 to appropriate human interface components located elsewhere on the network. Human interface components can include any component that allows the computer to take input from, or send output to, a human user of a computer.

Memory 204 may include RAM, ROM, and/or other types of memory. Memory 204 illustrates an example of computer-readable storage media (devices) for storage of information such as computer-readable instructions, data structures, program modules or other data. Memory 204 may store BIOS 208 for controlling low-level operation of server device 200. The memory may also store operating system 206 for controlling the operation of server device 200. It will be appreciated that this component may include a general-purpose operating system such as a version of UNIX, or LINUX™, or a specialized operating system such as Microsoft Corporation's Windows® operating system, or the Apple Corporation's iOS® operating system. The operating system may include, or interface with a Java virtual machine module that enables control of hardware components and/or operating system operations via Java application programs.

Memory 204 may further include one or more data storage 210, which can be utilized by server device 200 to store, among other things, applications 220 and/or other data. For example, data storage 210 may also be employed to store information that describes various capabilities of server device 200. The information may then be provided to another device based on any of a variety of events, including being sent as part of a header during a communication, sent upon request, or the like. Data storage 210 may also be employed to store social networking information including address books, buddy lists, aliases, user profile information, or the like. Data stores 210 may further include program code, data, algorithms, and the like, for use by a processor, such as processor 202 to execute and perform actions. In one embodiment, at least some of data store 210 might also be stored on another component of server device 200, including, but not limited to, non-transitory media inside processor-readable removable storage device 236, processor-readable stationary storage device 234, or any other computer-readable storage device within server device 200, or even external to server device 200.

Data storage 210 may include, for example, documenting data database 212. In some embodiments, documenting data database 212 may store documenting data, including at least image data. In at least one embodiment, the documenting data may documents the condition of real and/or personal property at various points in time.

Applications 220 may include computer executable instructions which, when executed by server device 200, transmit, receive, and/or otherwise process messages (e.g., SMS, MMS, Instant Message (IM), email, and/or other messages), audio, video, and enable telecommunication with another user of another client device. Other examples of application programs include calendars, search programs, email client applications, IM applications, SMS applications, Voice Over Internet Protocol (VoIP) applications, contact managers, task managers, transcoders, database programs, word processing programs, security applications, spreadsheet programs, games, search programs, and so forth. Applications 220 may include, for example, condition assessment server application 222.

Condition assessment server application 222 may be configured to enable the assessment of a condition of real and/or personal property based on at least documenting data. In at least one embodiment, condition assessment server application 222 may interact with a client device for enabling the assessment of a condition of real and/or personal property based on at least documenting data. In some embodiments, condition assessment server application 222 may be employed by server device 112 of FIG. 1, or any combination of server devices. In any event, condition assessment server application 222 may employ processes, or parts or processes, similar to those described in conjunction with FIGS. 4-5, to perform at least some actions.

### Illustrative Network Device

FIG. 3 shows one embodiment of client device 300 that may include many more or less components than those shown. Client device 300 may represent, for example, at least one embodiment of client devices 122-128 shown in FIG. 1.

Client device 300 may include processor 302 in communication with memory 304 via bus 328. Client device 300 may also include power supply 330, network interface 332, audio interface 356, display 350, keypad 352, illuminator 354, video interface 342, input/output interface 338, haptic interface 364, global positioning systems (GPS) receiver 358, open air gesture interface 360, temperature interface 362, camera(s) 340, projector 346, pointing device interface 366, processor-readable stationary storage device 334, and processor-readable removable storage device 336. Client device 300 may optionally communicate with a base station (not shown), or directly with another computing device. And in one embodiment, although not shown, a gyroscope may be employed within client device 300 to measuring and/or maintaining an orientation of client device 300.

Power supply 330 may provide power to client device 300. A rechargeable or non-rechargeable battery may be used to provide power. The power may also be provided by an external power source, such as an AC adapter or a powered docking cradle that supplements and/or recharges the battery.

Network interface 332 includes circuitry for coupling client device 300 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 332 is sometimes known as a transceiver, transceiving device, or network interface card (NIC).

Audio interface 356 may be arranged to produce and receive audio signals such as the sound of a human voice. For example, audio interface 356 may be coupled to a speaker and microphone (not shown) to enable telecommunication with others and/or generate an audio acknowledgement for some action. A microphone in audio interface 356 can also be used for input to or control of client device 300, e.g., using voice recognition, detecting touch based on sound, and the like.

Display 350 may be a liquid crystal display (LCD), gas plasma, electronic ink, light emitting diode (LED), Organic LED (OLED) or any other type of light reflective or light transmissive display that can be used with a computing device. Display 350 may also include a touch interface 344 arranged to receive input from an object such as a stylus or a digit from a human hand, and may use resistive, capacitive, surface acoustic wave (SAW), infrared, radar, or other technologies to sense touch and/or gestures.

Projector 346 may be a remote handheld projector or an integrated projector that is capable of projecting an image on a remote wall or any other reflective object such as a remote screen.

Video interface 342 may be arranged to capture video images, such as a still photo, a video segment, an infrared video, or the like. For example, video interface 342 may be coupled to a digital video camera, a web-camera, or the like. Video interface 342 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 352 may comprise any input device arranged to receive input from a user. For example, keypad 352 may include a push button numeric dial, or a keyboard. Keypad 352 may also include command buttons that are associated with selecting and sending images.

Illuminator 354 may provide a status indication and/or provide light. Illuminator 354 may remain active for specific periods of time or in response to events. For example, when illuminator 354 is active, it may backlight the buttons on keypad 352 and stay on while the client device is powered. Also, illuminator 354 may backlight these buttons in various patterns when particular actions are performed, such as dialing another client device. Illuminator 354 may also cause light sources positioned within a transparent or translucent case of the client device to illuminate in response to actions.

Client device 300 may also comprise input/output interface 338 for communicating with external peripheral devices or other computing devices such as other client devices and network devices. The peripheral devices may include an audio headset, display screen glasses, remote speaker system, remote speaker and microphone system, and the like. Input/output interface 338 can utilize one or more technologies, such as Universal Serial Bus (USB), Infrared, WiFi, WiMax, Bluetooth™, and the like.

Haptic interface 364 may be arranged to provide tactile feedback to a user of the client device. For example, the haptic interface 364 may be employed to vibrate client device 300 in a particular way when another user of a computing device is calling. Temperature interface 362 may be used to provide a temperature measurement input and/or a temperature changing output to a user of client device 300. Open air gesture interface 360 may sense physical gestures of a user of client device 300, for example, by using single or stereo video cameras, radar, a gyroscopic sensor inside a device held or worn by the user, or the like. Camera 340 may be used to track physical eye movements of a user of client device 300.

GPS transceiver 358 can determine the physical coordinates of client device 300 on the surface of the Earth, which typically outputs a location as latitude and longitude values. GPS transceiver 358 can also employ other geo-positioning mechanisms, including, but not limited to, triangulation, assisted GPS (AGPS), Enhanced Observed Time Difference (EOTD), Cell Identifier (CI), Service Area Identifier (SAI), Enhanced Timing Advance (ETA), Base Station Subsystem (BSS), or the like, to further determine the physical location of client device 300 on the surface of the Earth. It is understood that under different conditions, GPS transceiver 358 can determine a physical location for client device 300. In at least one embodiment, however, client device 300 may, through other components, provide other information that may be employed to determine a physical location of the device, including for example, a Media Access Control (MAC) address, IP address, and the like.

Human interface components can be peripheral devices that are physically separate from client device 300, allowing for remote input and/or output to client device 300. For example, information routed as described here through human interface components such as display 350 or keyboard 352 can instead be routed through network interface 332 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client device with such peripheral human interface components is a wearable computing device, which might include a remote pico projector along with one or more cameras that remotely communicate with a separately located client device to sense a user's gestures toward portions of an image projected by the pico projector onto a reflected surface such as a wall or the user's hand.

A client device may include a browser application 324 that is configured to receive and to send web pages, web-based messages, graphics, text, multimedia, and the like. The client device's browser application 324 may employ virtually any programming language, including a wireless application protocol messages (WAP), and the like. In at least one embodiment, the browser application 324 is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 304 may include RAM, ROM, and/or other types of memory. Memory 304 illustrates an example of computer-readable storage media (devices) for storage of information such as computer-readable instructions, data structures, program modules or other data. Memory 304 may store BIOS 308 for controlling low-level operation of client device 300. The memory may also store operating system 306 for controlling the operation of client device 300. It will be appreciated that this component may include a general-purpose operating system such as a version of UNIX, or LINUX™, or a specialized mobile computer communication operating system such as Windows Phone™, or the Symbian® operating system. The operating system may include, or interface with a Java virtual machine module that enables control of hardware components and/or operating system operations via Java application programs.

Memory 304 may further include one or more data storage 310, which can be utilized by client device 300 to store, among other things, applications 320 and/or other data. For example, data storage 310 may also be employed to store information that describes various capabilities of client device 300. The information may then be provided to another device based on any of a variety of events, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by a processor, such as processor 302 to execute and perform actions. In one embodiment, at least some of data storage 310 might also be stored on another component of client device 300, including, but not limited to, non-transitory processor-readable removable storage device 336, processor-readable stationary storage device 334, or even external to the client device.

Data storage 310 may include, for example, documenting data storage 312. In some embodiments, documenting data storage 312 may store data that documents the condition of real and/or personal property. Such documenting data includes at least image data.

Applications 320 may include computer executable instructions which, when executed by client device 300, transmit, receive, and/or otherwise process instructions and data. Applications 320 may include, for example, condition assessment client application 322. Other examples of application programs include calendars, search programs, email client applications, IM applications, SMS applications, Voice Over Internet Protocol (VoIP) applications, contact managers, task managers, transcoders, database programs, word processing programs, security applications, spreadsheet programs, games, search programs, and so forth.

Condition assessment client application 322 may be configured to enable the assessment of conditions of real and/or personal property. In at least one embodiment, condition assessment client application 322 may interact with a server device for enabling the assessment of conditions of real and/or personal property. In at least one embodiment, condition assessment application 322 may be a specialized application. In at least one embodiment, condition assessment client application 322 may interact with browser application 324. In some embodiments, condition assessment client application 322 may be employed by at least one of client devices 122-128 of FIG. 1, or any combination of client devices. In any event, condition assessment client application 322 may employ processes, or parts or processes, similar to those described in conjunction with FIGS. 4-5, to perform at least some actions.

The above specification, examples, and data provide a complete description of the composition, manufacture, and use of the invention. Since many embodiments of the invention can be made without departing from the spirit and scope of the invention, the invention resides in the claims hereinafter appended.

The embodiments of the invention in which an exclusive property or privilege is claimed are defined as follows:

1. A method for documenting conditions of tangible property with a client device, comprising the actions of:
capturing, by the client device, image data, wherein the image data includes image data of the property;
generating, by the client device, annotation data based on a determined feature of the image;
associating the annotation data with a region of the image data, wherein the region of the image data includes the determined feature of the property;
capturing, by the client device, additional image data, wherein at least a portion of the annotation data is displayed by the client device when capturing the additional image data; and
generating documenting data based on at least one of the image data, the annotation data, or the additional image data, wherein the documenting data documents a first condition of the property.

2. The method of claim 1, wherein capturing the image data includes capturing video data and generating the annotation data occurs concurrently with capturing at least a portion of the video data.

3. The method of claim 1, further comprising enabling a user to associate a touch notation to the region of the image data that includes the determined feature of the property, wherein the touch notation corresponds to an alpha-numeric string.

4. The method of claim 1, wherein generating annotation data includes selecting a notation overlay concurrently with capturing at least a portion of the image data.

5. The method of claim 1, wherein the generated annotation data includes at least one notation overlay selected from a plurality of notation overlays.

6. The method of claim 1, further comprising enabling a user of the client device to control a review of at least a portion of the image data by utilizing a progress ribbon.

7. The method of claim 1, further comprising blending at least a portion of the annotation data with at least a portion of the image for simultaneous display on a display of the client device.

8. The method of claim 1, wherein the region of the image data that is associated with the annotation data corresponds to a portion of a display of the client device that is selected by a user of the client device.

9. A computer readable non-transitive storage media that includes instructions for documenting conditions of tangible property with a client device, comprising the actions of:
capturing, by the client device, image data, wherein the image data includes image data of the property;
generating, by the client device, annotation data based on a determined feature of the image;
associating the annotation data with a region of the image data, wherein the region of the image data includes the determined feature of the property;
capturing, by the client device, additional image data, wherein at least a portion of the annotation data is displayed by the client device when capturing the additional image data; and
generating documenting data based on at least one of the image data, the annotation data, or the additional image data, wherein the documenting data documents a first condition of the property.

10. The media of claim 9, wherein capturing the image data includes capturing video data and generating the annotation data occurs concurrently with capturing at least a portion of the video data.

11. The media of claim 9, wherein generating annotation data is based on a user touching a display of the client device, wherein the user touches the display when the display is displaying at least a portion of the image.

12. The media of claim 9, the actions further comprising enabling a user to associate a touch notation to the region of the image data that includes the determined feature of the property, wherein the touch notation corresponds to an alpha-numeric string.

13. The media of claim 9, further comprising blending at least a portion of the annotation data with at least a portion of the image for simultaneous display on a display of the client device.

14. The media of claim 9, wherein the region of the image data that is associated with the annotation data corresponds to a portion of a display of the client device that is selected by a user of the client device.

15. A system for documenting conditions of tangible property with a client device, comprising:
capturing, by the client device, image data, wherein the image data includes image data of the property;
generating, by the client device, annotation data based on a determined feature of the image;
associating the annotation data with a region of the image data, wherein the region of the image data includes the determined feature of the property;
capturing, by the client device, additional image data, wherein at least a portion of the annotation data is displayed by the client device when capturing the additional image data; and
generating documenting data based on at least one of the image data, the annotation data, or the additional image data, wherein the documenting data documents a first condition of the property.

16. The system of claim 15, wherein capturing the image data includes capturing video data and generating the annotation data occurs concurrently with capturing at least a portion of the video data.

17. The system of claim 15, wherein generating annotation data is based on a user touching a display of the client device, wherein the user touches the display when the display is displaying at least a portion of the image.

18. The system of claim 15, further comprising enabling a user to associate a touch notation to the region of the image data that includes the determined feature of the property, wherein the touch notation corresponds to an alpha-numeric string.

19. The system of claim 15, wherein the generated annotation data includes at least one notation overlay selected from a plurality of notation overlays.

20. The system of claim 15, further comprising blending at least a portion of the annotation data with at least a portion of the image for simultaneous display on a display of the client device.
